(19) United States
(12) Patent Application Publication
(10) Pub. No.: US 2021/0142405 A1
(43) Pub. Date: May 13, 2021

(54) SYSTEM AND METHOD FOR PROVIDING AN OWNERSHIP CONVEYANCE SYSTEM AND/OR MARKETPLACE

(71) Applicant: Social Equity Incorporated, Sheridan, WY (US)

(72) Inventor: Peter Dwight Sahagen, Sheridan, WY (US)

(73) Assignee: Social Equity Incorporated, Sheridan, WY (US)

(21) Appl. No.: 17/150,707

(22) Filed: Jan. 15, 2021

Related U.S. Application Data
(63) Continuation-in-part of application No. 16/237,625, filed on Dec. 31, 2018.
Application No. 16/237,625 is a continuation-in-part of application No. 16/283,400, filed on Feb. 22, 2019.
Application No. 16/283,400 is a continuation-in-part of application No. 16/358,749, filed on Mar. 20, 2019.

(51) Int. Cl. G06Q 40/02; G06Q 50/18

(52) U.S. Cl. CPC G06Q 40/025; G06Q 50/182

(57) ABSTRACT

A computerized method for providing an ownership conveyance system, said computerized method using a mortgage processing module, a trust processing module, a processor and a communications device is disclosed. The method includes providing a fractionalizable mortgage instrument of a lender, receiving a mortgage instrument request data from a buyer for the fractionalizable mortgage instrument, generating a mortgage instrument agreement data for the fractionalizable mortgage instrument based on the mortgage instrument request data, receiving title data at the trust processing module of a fractionalized real estate unit purchased using the fractionalizable mortgage instrument, determining if a default event, which is based on the mortgage instrument agreement data, occurs, and automatically transferring title data from the trust processing module to an assignee module of the lender when the default event occurs. The buyer is a beneficiary of a trust operated by the trust processing module.

### CROSS REFERENCE TO RELATED APPLICATIONS

This application claims the benefit of U.S. patent application Ser. No. 16/358,749, entitled “SYSTEM AND METHOD FOR PROVIDING ONBOARDING, CONFIGURATION AND EXCHANGE OF REAL ESTATE UNITS INTO A REAL ESTATE OWNERSHIP MOBILITY PLATFORM,” filed on Mar. 20, 2019, U.S. patent application Ser. No. 16/237,625, entitled “SYSTEM AND METHOD FOR PROVIDING AUTOMATED REAL ESTATE OWNERSHIP MOBILITY,” filed on Dec. 31, 2018, and U.S. patent application Ser. No. 16/283,400, entitled “SYSTEM AND METHOD FOR PROVIDING AUTOMATED SOCIAL CONTRACTS FOR SHARED REAL ESTATE ENVIRONMENTS,” filed on Feb. 22, 2019. This application incorporates the entire contents of the above-referenced applications herein by reference.

### FIELD OF INVENTION

The present disclosure relates to methods and systems for providing an ownership conveyance system such as, for example, including providing a fractionalizable mortgage instrument, which may also provide easy transfer or “mobility” of consumer home equity and/or equity interests and/or real estate units (which may include equity interests or contingent equity interests or beneficial interests such as trusts). For example, the ownership conveyance system and/or marketplace may include providing a fractionalizable mortgage instrument that may provide easy transfer or “mobility” of consumer home equity and/or equity interests for example among one or more social frameworks.

### BACKGROUND

Due to the ever-increasing cost of real estate, more and more individuals are being excluded from the possibility of owning real estate, at least until later period in life than have been prevalent in the past. Especially in urban and prime sub-urban locations, ownership of a home or apartment is largely out of the question for most younger individuals, and even many older individuals in lower to middle wage-earning demographics.

Instead, these various groups of individuals that do not own real estate and currently have no viable means to obtain real estate, turn to renting residences. Unlike ownership in a home, where equity is built over time, rental units require a tenant to simply pay money for the residence while generally being excluded from any meaningful equity or equity accretion in the residence.

Another common practice in high density population areas, like urban and sub-urban areas, is for these groups of individuals to enter into leases for rental properties with other individuals, whereby the individuals share a single rental unit. Commonly referred to in various locations as roommates, flatmates, housemates, or other term used to denote individuals un-related biologically yet living together, these joint living situations are especially common among younger individuals who may not have the affluence to afford the down payments required for real estate ownership outright. As the cost of real estate continues to outpace real wage increases, this practice will be come even more common, and for longer periods of an individual's life.

Finally, given the high transaction costs associated with real estate transactions, from listing costs, to commissions paid to agents and brokers, to title fees, attorney fees, and state title transfer fees, real estate units are generally something that an individual must hold onto for a period of time in order to realize any gains. Further, real estate is generally only able to be purchased in whole units (e.g. a house, an apartment), rather than individual portions. The only way that individuals can share ownership of whole units is to have each individual listed on deed or other ownership record. In general, this makes Real estate, in the current transactional form, limited in both ownership frameworks and mobility.

Whereas individuals may desire to have ownership in fractional shares or portions of existing real estate units, no system of the sort exists currently wherein equity ownership interests begin at the outset (e.g., as opposed to rent-to-own systems that are generally tricks to cause a consumer to pay higher rent/lease payments). Nor are there systems capable of generating and processing fractional shares or portions of existing real estate units, which would make such a network of fractional real estate unit ownership work

Other features missing in today's systems is the ability to implement exportable, and networkable and tradable fractional real estate units, with or without the ability to apply financing and equity growth in such fractional real estate units. Ideally, a system would need to be able to make real estate units exportable, networkable, and tradable based upon fair, logical, and rule based fractionalization and as a result which takes into account as many value influencing factors as possible. Another feature missing in today's systems is the capability to significantly lower costs such as transfer, tax, real estate titling and retitling costs, real estate title insurance, high closing costs, and transactional intermediaries' fees.

Therefore, there is a need in the art for systems and methods for providing onboarding, configuration and exchange of real estate units into a real estate ownership mobility platform including mortgages in a manner that overcomes the limitations described above. There is also a need to efficiently buy, sell, and swap, and the ability to pay or be paid a difference through various forms of legal payment.

### SUMMARY OF INVENTION

In one exemplary aspect, the present disclosure is directed to a computerized method for providing an ownership conveyance system, said computerized method using a mortgage processing module, a trust processing module, a processor and a communications device. The method includes providing a fractionalizable mortgage instrument of a lender, receiving a mortgage instrument request data from a buyer for the fractionalizable mortgage instrument, generating a mortgage instrument agreement data for the fractionalizable mortgage instrument based on the mortgage instrument request data, receiving title data at the trust processing module of a fractionalized real estate unit purchased using the fractionalizable mortgage instrument, determining if one or more default events, which is based on the mortgage instrument agreement data, occurs, and automatically transferring title data from the trust processing module to an assignee module of the lender when the final default event occurs net of any cure periods. The buyer is a beneficiary of a trust operated by the trust processing module.

In another exemplary aspect, the present disclosure is directed to a computerized system for providing conveyance of ownership, of equity interests, or of “effective ownership” (whether contingent or not). The system includes a mortgage processing module and a trust processing module, comprising computer-executable code stored in non-volatile memory, a processor, and one or more communications devices. The mortgage processing module and the trust processing module, the processor, and the one or more communications devices are configured to provide a fractionalizable mortgage instrument of a lender, receive a mortgage instrument request data from a buyer for the fractionalizable mortgage instrument, generate a mortgage instrument agreement data for the fractionalizable mortgage instrument based on the mortgage instrument request data, receive title data at the trust processing module of a fractionalized real estate unit purchased using the fractionalizable mortgage instrument, determine if a default event, which is based on the mortgage instrument agreement data, occurs, and automatically transfer title data from the trust processing module to an assignee module of the lender when the default event occurs. The buyer is a beneficiary of a trust operated by the trust processing module.

Accordingly, the subject matter described herein provides systems, methods, and computer-readable non-transitory storage mediums for providing onboarding, configuration and exchange of real estate units into a real estate ownership mobility platform.

According to an embodiment of the present invention, a computerized method for providing onboarding, configuration and exchange of real estate units into a real estate ownership mobility platform, said computerized method using a real estate unit fractionalization module, a processor and a communications device, and the method comprises the steps of: receiving a real estate unit fractionalization request from an owner (or beneficial owner) of a real estate unit; generating a real estate unit dataset, wherein said real estate unit dataset is based at least in part on information derived from said real estate unit fractionalization request, and wherein said real estate unit dataset comprises information associated with at least one real estate unit to be onboarded onto a fractionalized real estate unit network; determining, from said real estate unit dataset, a set of fractionalized real estate units, wherein said set of fractionalized real estate units comprises one or more fractionalized real estate units; generating, based on said real estate unit dataset, values for each of said one or more fractionalized real estate units in said set of fractionalized real estate units; generating a set of real estate unit tokens comprising one or more real estate unit tokens for each of said fractionalized real estate units in said set of fractionalized real estate units; and distributing one or more token offerings on said fractionalized real estate unit network.

According to an embodiment of the present invention, data from said real estate unit dataset used in calculating values for each of said one or more fractionalized real estate units comprises data related to physical characteristics of a real estate unit.

According to an embodiment of the present invention, the method further comprises the step of generating an optimal fractionalization of a real estate unit identified in said real estate unit dataset, wherein said optimal fractionalization is based, at least in part, on creating livable sub-spaces in the real estate unit that can be for example tokenized for use on said fractionalized real estate unit network.

According to an embodiment of the present invention, livable sub-spaces each comprise an identification of a bedroom.

According to an embodiment of the present invention, livable sub-spaces each comprise a fractional ownership equity right in one or more common interior and/or exterior space.

According to an embodiment of the present invention, the method may further comprise the steps of: receiving a recombination request; confirming all or a majority of fractional real estate unit owners acknowledge the recombination request; and combining one or more fractional real estate units into a single real estate unit.

According to an embodiment of the present invention, values for each of said one or more fractionalized real estate units in said set of fractionalized real estate units is based at least in part on local real estate values in the area where said one or more fractionalized real estate units are located and characteristics of each of said one or more fractionalized real estate units.

According to an embodiment of the present invention, characteristics may be selected from the group comprising, size of bedroom, location of bedroom, indication of private bathroom, size of closets, indication of amenities, view, noise factors, and indication of proportion of size in comparison to the entire set of fractionalized real estate units.

According to an embodiment of the present invention, the method further comprises the steps of: receiving a token transaction associated with one or more of said one or more token offerings; executing said token transaction; and distributing a value associated with said token transaction to said owner of said real estate unit.

According to an embodiment of the present invention, the value may be selected from the group comprising: fiat currency, crypto-currency, ownership in any other valuable instrument, such as securities or commodities.

According to an embodiment of the present invention, the method further comprises the step of recording said token transaction and executing one or more smart contracts associated with a fractional real estate unit identified in said token transaction.

According to an embodiment of the present invention, the method further comprises the step of generating a valuation analysis and equity analysis in one or more of said one or more smart contracts.

According to an embodiment of the present invention, at least one of said one or more smart contracts is a housing club constitution.

According to an embodiment of the present invention, a computerized system for providing onboarding, configuration and exchange of real estate units into a real estate ownership mobility platform comprises: a real estate unit fractionalization module, comprising computer-executable code stored in non-volatile memory; a processor; and one or more communications device; wherein the real estate unit fractionalization module, the processor, and the one or more communications device are configured to: receive a real estate unit fractionalization request from an owner of a real estate unit; generate a real estate unit dataset, wherein said real estate unit dataset is based at least in part on information derived from said real estate unit fractionalization request, and wherein said real estate unit dataset comprises information associated with at least one real estate unit to be onboarded onto a fractionalized real estate unit network; determine, from said real estate unit dataset, a set of fractionalized real estate units, wherein said set of fractionalized real estate units comprises one or more fractionalized real estate units; generate, based on said real estate unit dataset, values for each of said one or more fractionalized real estate units in said set of fractionalized real estate units; generate a set of real estate unit tokens comprising one or more real estate unit tokens for each of said fractionalized real estate units in said set of fractionalized real estate units; and distribute one or more token offerings on said fractionalized real estate unit network.

According to an embodiment of the present invention, the real estate unit fractionalization module, the processor, and the one or more communications device are further configured to generate an optimal fractionalization of a real estate unit identified in said real estate unit dataset, wherein said optimal fractionalization is based, at least in part, on creating livable sub-spaces in the real estate unit that can be tokenized for use on said fractionalized real estate unit network, on a non-fractionalized real estate unit network, or combination of the two.

According to an embodiment of the present invention, the real estate unit fractionalization module, the processor, and the one or more communications device are further configured to: receive a token transaction associated with one or more of said one or more token offerings; execute said token transaction; and distribute a value associated with said token transaction to said owner of said real estate unit.

According to an embodiment of the present invention, the real estate unit fractionalization module, the processor, and the one or more communications device are further configured to record said token transaction and executing one or more smart contracts associated with a fractional real estate unit identified in said token transaction.

According to an embodiment of the present invention, the real estate unit fractionalization module, the processor, and the one or more communications device are further configured to generate a valuation analysis and equity analysis in one or more of said one or more smart contracts.

Various objects, features, aspects and advantages of the disclosed subject matter will become more apparent from the following detailed description of embodiments, along with the accompanying drawing figures in which like numerals represent like components.

### BRIEF DESCRIPTION OF THE DRAWINGS

FIG. 1 is an illustration of a system for providing onboarding, configuration and exchange of real estate units into a real estate ownership mobility platform, in accordance with an embodiment of the present invention.

FIG. 2 is an illustration of a system for providing onboarding, configuration and exchange of real estate units into a real estate ownership mobility platform, in accordance with an embodiment of the present invention.

FIG. 3 is an exemplary embodiment of a method for providing onboarding, configuration and exchange of real estate units into a real estate ownership mobility platform.

FIG. 4 is an exemplary embodiment of a method for providing onboarding, configuration and exchange of real estate units into a real estate ownership mobility platform.

FIG. 5 is an illustration of a system for providing an ownership conveyance system, in accordance with an embodiment of the present invention.

FIG. 6 is an exemplary embodiment of a method for providing an ownership conveyance system, in accordance with an embodiment of the present invention.

### DETAILED DESCRIPTION

The present disclosure relates to methods and systems for providing onboarding, configuration and exchange of real estate units into a real estate ownership mobility platform. More specifically embodiments of the present invention are directed to systems and methods for fractionalizing real estate units into tokenizable commodities and managing the exchange of transactions associated with those tokenized commodities to allow for home ownership mobility. The fractionalized real estate units may include for example portions of a real estate unit and/or equity interests.

Preferred embodiments of the present invention are partially directed at updating and altering the meaning and practical definition of residential “ownership” to meet the demands for “care free” management and extreme mobility of younger generations. Embodiments of the present invention are directed in part to enable creation of a new type of residential “HOME OWNERSHIP MOBILITY” which seems well-suited to younger generations of individuals.

According to an embodiment of the present invention, the system enables in both local and global ownership: extreme mobility, social management via social {AND SOCIO-LOGICAL} frameworking {(CREATING PRESET FRAMEWORKS TO FACILITATE, OPTIMIZE, AND DEFINE VARIOUS SOCIAL GROUPINGS (CREATE A “HOME UNIT”) and a rewards and penalties gradient ethical system between users/customers (“Members”). In certain embodiments, the system is configured to automate and process legal and financial management and partial ownership of real estate units, as well as provide for “in-boarding” of full real estate units and/or swapping of parts of full real estate units for other partial real estate units, and the intelligent swapping of ownership between partial or complete real estate units. Real estate units may be comprised of one or more types of real estate property, including, but not limited to, houses, apartments, condominiums, time shares, townhouses, multi-unit structures such as hotels, or combinations thereof. One of ordinary skill in the art would appreciate that there are numerous types of real estate units and embodiments of the present invention are contemplated for use with any appropriate type of real estate units. Further, while preferred embodiments of the present invention are directed primarily at residential real estate units, embodiments of the present invention could be used for other types of real estate units as well, such as commercial real estate units and retail real estate units, and embodiments of the present invention are contemplated for use with such real estate units.

According to an embodiment of the present invention, while moving around within specified rules, the system gives members the ability to accumulate equity in real estate units, even while swapping ownership of such real estate units and moving around. The system allows for members payments to be made towards paying down a mortgage on a real estate unit somewhere, while still providing mobility.

Preferred embodiments of the present invention also provide a system that enables members to be paid their pro-rata equity accretions on real properties as a mortgage gets paid down and as property's values rises over time without needing to wait for long term liquidity events to get access to their capital. This feature may be implemented, for instance, via smart contracts. In this preferred embodiment, smart contracts are computer implemented transaction protocol that automatically processes the terms of a contract/transaction. Smart contracts may be implemented, for instance via one or more distributed ledgers or replicated asset registries. One of ordinary skill in the art would appreciate that there are numerous means to implement these smart contract features, and embodiments of the present invention are contemplated for use with any appropriate means for providing and implementing these smart contact features.

In a preferred embodiment, a semi-open (permissioned) distributed ledger technology (DLT) system is utilized to intelligently divide ownership shares via the use of certain smart algorithms and to standardize the division of real estate units. In this manner, the system may be configured to divide ownership in any real estate unit worldwide in a fair manner. This allows the system to provide to members the ability swap real estate units (including fractional ownership thereof), and such swaps may occur via a global exchange platform. The system may leverage the DLT system or other distributed ledger (e.g., blockchain exchange) to record these transactions. In this disclosure, fractional ownership of real estate units create a collective of individuals or families with beneficial interest in a single real estate unit (referred to herein as a MICRO-COOP.

According to an embodiment of the present invention, the system provides a new real property purchasing and swapping methodology and protocol which enables individuals who otherwise would not be eligible to purchase real estate under the current dominant global credit system. Further, since preferred embodiments, the underlying real estate units will be owned by legal entities, not individuals, “ownership” of real estate units may be made possible to individuals in places where they would not otherwise be able to own property, such as in countries that require citizenship or have other restrictions with regards to who can own property in said country.

Herein, when “ownership,” “owners” of a fractional real estate unit is used, or “interest” in a fractional real estate unit, it may refer to either legal ownership, such as via title or other government associated right, or “beneficial ownership”, which refers to the rights of users in a fractional real estate unit.

According to an embodiment of the present invention, the computerized systems utilized to enable the methodologies detailed herein are cloud based and managed, with certain components being preferably implemented in distributed means, such as the smart contracts which would use distributed ledger means.

In a preferred embodiment, a core of the system utilizes a distributed ledger component (e.g., DLT, blockchain), “automated social frameworking” and a system and network of interlocking trusts/legal entities in creating a new type of Home Ownership Mobility which is a competitive system to today's renting/leasing residential property conventions. Greater mobility, convenience, and far better economics for the customer/resident are generally achieved. The system enables the customer/resident to recapture some, most, or some times all of their funds over time which would have otherwise been wasted rent. The automated social framework may for example link homes together and may link different social frameworks together (e.g., data of a plurality of homes and/or a plurality of social frameworks may be stored, including indications of the relations between the data, and analyzed and processed).

In a preferred embodiment, the system enables the near instantaneous exchange of ownership title and equity benefit in a trust-less manner utilizing “social frameworks” and Distributed Ledger Technologies (“DLT”) such as blockchain or Directed Acyclic Graphs (“DAG”s, such as Hashgraph.) The system, in a preferred embodiment, also enables partial ownership of a home and the exchange of “partial ownership titles” and financial benefit to the customer for pro-rata equity accretion including automated “smart contract” access to liquidity in an on-going basis.

The system in the preferred embodiment supports partial or fractional ownership of real estate units where membership in the underlying real estate unit is subject to terms of an agreement amongst its members, referred to herein as a Housing Club Constitution. Via the system, these private housing club(s) allow members to create a set of by-laws for fractionally owned real estate units which allows for members to be in control over whom they wish to associate with in their real estate units. Such private housing clubs assist in providing housing for members and wherein membership acceptance criteria is used to create a group of people who become party to an Housing Club Constitution. Such a private housing club may offer and administer member benefits, rules, rewards, and penalties and may offer activities, social or career introductions, education, arbitrations, and/or other perks. A Housing Club Constitution may require members to honor the location specific “House Rules” and/or their “home constitution” agreed upon by the residents of a particular apartment or house and also calls for the reward of certain agreed upon positive behavior and likewise the penalization of negative behavior. Automation of the execution such rewards and penalties associated with a Housing Club Constitution may be implemented, for instance, via smart contract or other computer implemented and regulated means provided by the system.

In certain embodiments, a membership club constitution not related to a specific home and often additionally a Home Constitution may be implemented which limits or sets forth preferred requirements for a member to join in fractional ownership of a particular real estate unit. An example case for this is the fractional ownership of a multi-bedroom unit, wherein each member will be obtaining fractional ownership in the real estate unit, wherein the fractional ownership is associated with a particular bedroom within the multi-bedroom unit. Given, in this example case, there will be multiple members sharing the common areas (e.g., bathrooms, kitchen, living room) of a multi-bedroom unit, it is desirable to have a set of rules that are commonly acceptable to the members. While the Housing Club Constitution may include certain objective rules that should be complied with, such as not leaving dishes in a sink, not smoking indoors, not having one or more forms of pets, or not having more than a certain number of overnight guests at a time, the system may be configured to allow the members to set subjective standards in the Housing Club Constitution as well.

Further, the system may be configured to allow for the House Club Constitution to have elements for setting requirements, criteria or suggestions for allowing new members to enter into the Housing Club Constitution (e.g., replace an existing member with a new member). For instance, the system may allow for the Housing Club Constitution to identify certain restrictions, criteria, preferences or suggestions on potential member's characteristics (e.g., gender, nationality, religion—e.g., in countries where this is legal and/or mandated such as Muslim countries wherein it is illegal for unrelated members of the opposite sex to live together), like-minded matching such as “Tiered Preference Matching” of desired traits (e.g., cleanliness, honesty, openness), and/or creating living environs focused on desired activities such as sports, computer games, or other objective or subjective data point in order to ensure the members of a private housing club to maintain a particular desired atmosphere for a real estate unit. In at least some exemplary embodiments, “Tiered Preference Matching” may be used for example in an arbitrarily chosen three-tiered-system (e.g., including a first level of what one has to have, a second level of what one would like to have, and a third or bottom level of what would be nice to have but not as important of a factor as the first and second levels).

In conjunction with the aforementioned usage of the Housing Club Constitution, the system may be configured to utilize training models and predictive analytics to identify to members and potential members matches for real estate units that suit their own characteristics and the characteristics of real estate units to determine whether a particular member would be a good fit for a particular real estate unit. As the system has access to data points from both the member and the real estate unit, and will have an ever-increasing number of data points related to how relationships transpired (e.g., good, bad, neutral) between and amongst members, Housing Club Constitutions and/or real estate units. Ultimately, when the system has enough data points at its disposal, the system will be extremely accurate at identifying potentially sublime matches between members and real estate units.

In a preferred embodiment, “Social Frameworks”, of which the House Club Constitution is one, are further supported and provided by the system in a networked structure. Ratings of individual members/users (i.e., Social ratings), financial rewards (which may be implemented in cryptocurrency and/or fiat currency) and financial fines (which may be implemented cryptocurrency and/or fiat currency) may be administered based upon social behavior, ratings, and on time or late payments—as prescribed in the House Club Constitution.

In preferred embodiments, the system employs a networked ownership platform. The networked ownership platform is configured to manage and oversee, in part, a distributed yet cooperating network of individual legal entities which are trusts or trust-like entities to hold legal title to real properties and reserve much of the beneficial title for the benefit of the members who are legally limited beneficiaries in these entities. In certain embodiments, a network or networks of trustees or managers led by a common trust services company or alternatively a network of decentralized cooperating trustees or managers utilize the system, which provides cloud management and artificial intelligence to provide services to value, maintain, or improve real properties with the focus of accreting greater value over time and assists in the enforcement of the agreed upon rules of a Housing Club Constitution when it comes to fees, fines, and occupancy rights of resident club members. These trustees or managers of individual real properties may contractually cooperate with each other in supporting resident owner swaps and management as such activity comports to both an agreed upon housing club constitution and to individual resident House Rules.

In certain embodiments, the system may fully automate the process of maintaining and managing the associated real legal entities, maintaining and managing the real estate units, and maintaining and managing the enforcement of Housing Club Constitutions. Through a series of automated processes and artificial intelligence means, the system may be configured to automate these features, such as automatically processing administrative actions related to a trust or real estate unit (e.g., payment of mortgages, submission of taxes, generation and submission of legally required forms).

In a preferred embodiment of the present invention, the social rewards component and equity payment component of the system enable the payment of currency (e.g., fiat, crypto) to or by a member, regardless of any country in which the member or real estate unit is in, and may guarantee that the price of the currency is pegged to the national fiat currency in which the member is situated without added financial risk to either the member or the system.

The system, in at least one preferred embodiment, utilizes cloud management and AI to manage the member experience in a decentralized social housing club (or group operating with or within one or more social frameworks) across a geographically decentralized physical network of real estate units, wherein residential, cultural, and certain financial information is made available to participants join the network.

Turning now to FIG. 1, an exemplary system for providing onboarding, configuration and exchange of real estate units into a real estate ownership mobility platform is shown, in accordance with an embodiment of the present invention. The system comprises: one or more communications device, such as circuitry for wireless communications, circuitry for wired communications, circuitry for voice or data communications, or any other communications systems; one or more data stores 102, such as a database, file repository system, or other non-transitory storage medium; one or more processors 103, such as a central processing unit (CPU) or other specialized processing device; one or more memory devices 104, such as RAM, ROM, cache or other memory system; a real estate (RE) unit fractionalization module 105; and a tokenization module 106.

Turning now to FIG. 2, an exemplary system for providing onboarding, configuration and exchange of real estate units into a real estate ownership mobility platform is shown, in accordance with an embodiment of the present invention. The system comprises: one or more communications device, such as circuitry for wireless communications, circuitry for wired communications, circuitry for voice or data communications, or any other communications systems; one or more data stores 202, such as a database, file repository system, or other non-transitory storage medium; one or more processors 203, such as a central processing unit (CPU) or other specialized processing device; one or more memory devices 204, such as RAM, ROM, cache or other memory system; a real estate (RE) unit processing module 205; and a RE unit transaction module 206.

The embodiments shown in FIGS. 1 and 2 are merely exemplary embodiments of the present invention, and one of ordinary skill in the art would appreciate that the configurations could be adapted to use additional or fewer components, or otherwise combined or modified to provide the systems and methods detailed herein. As such, each of these modified embodiments are contemplated for use with the system and methods described herein.

Further, one of ordinary skill in the art would appreciate that portions of the system could be implemented in a variety of manners, such as locally on a computing device (e.g., smartphone), managed via a remote or distributed system and provided as a service (e.g., SaaS) layer between a contact and receiving elements of the user, or some combination thereof. As such, each of these implementations are contemplated for use with the system and methods described herein.

According to an embodiment of the present invention, the system may comprise one or more modules integrated or stored on a computer readable medium, or otherwise be accessible to a processor for instructing the processor to take various actions inline with the methods described herein. Modules may include, but are not limited to, a RE unit fractionalization module 105, a tokenization module 106, a RE unit processing module 205, a RE unit transaction module 206 or any combination thereof. One of ordinary skill in the art would appreciate that these modules could be implemented in various manners, and combined or further broken down into additional modules, depending on the architecture and implementation of the system.

According to an embodiment of the present invention, a RE Unit fractionalization module 106 is configured to take in data about a real estate unit, process that data, and generate a set of fractionalized units within the real estate unit. Data provided to a real estate unit fractionalization module may include, but is not limited to, floor plans or other architectural plans or blueprints, lists of amenities (e.g., fixtures, closets, appliances, HVAC systems, plumbing systems) lot size, data related to number of bedrooms, data related to number of bathrooms, data related to room size, data related to common areas, data related to physical location of the real estate unit, data related to the physical location of various rooms, or any combination thereof. The RE unit fractionalization module uses this data to automatically generate optimal fractionalized real estate units (FREU) that can be tokenized and placed onto a networked FREU platform. In this manner, the RE unit fractionalization module provides the ability to onboard new FREUs onto a networked FREU platform.

In preferred embodiments, the RE fractionalization module utilizes artificial intelligence means, neural network means, or machine learning (ML) means, to identify specific features in a real estate unit and generate optimal FREUs. For instance, for a RE fractionalization module that uses a machine learning technique, initial training data may be provided to the system related to what an optimal FREU generation would be from numerous initial real estate units. Then, decisions made by the RE fractionalization module could be initially monitored and trained based on its initial generation of optimal FREUs, eventually getting better overtime. In preferred embodiments, once trained, the RE fractionalization module would be able to generate optimal FREUs with near perfect accuracy. One of ordinary skill in the art would appreciate that there are numerous AI, neural network and ML techniques that could be utilized, and embodiments of the present invention are contemplated for use with any appropriate technique.

In some embodiments, the RE fractionalization module is configured to automatically generate optimal FREUs. In other embodiments, the RE fractionalization module may generate initial optimal FREU sets which may be reviewed by a user of the system before being tokenized.

According to an embodiment of the present invention, a tokenization module 105 is configured to take FREUs and tokenize them so that they may be appended to a networked FREU platform. The tokenization of the FREUs is so that the FREU may be identified via the token. In preferred embodiments of the present invention, the tokens may include information that identified the FREU, and any information associated with it (e.g., amenities, location, size, number of rooms, identification of common areas) as well as identify any smart contracts associated with a FREU, such as a housing club constitution.

In preferred embodiments, the tokenization module utilizes information provided to it by the RE Fractionalization module related to the FREUs to generate each token. In certain instances, a user onboarding a real estate unit onto a networked FREU platform may be provided the opportunity to add information to the token, such as rules for an initial housing club constitution. In other embodiments, the tokenization module may be configured to automatically create add information to the tokens, such as generating an initial housing club constitution based on information available to the system with regards to other housing club constitutions (e.g., other constitutions in the area, other constitutions in general, other constitutions based on demographics).

Once generated, the tokenization module may be configured to provide the tokens to a selected networked FREU platform for use in matching and trading in fractional ownership mobility.

According to an embodiment of the present invention, a real estate unit transaction module 205 is configured to provide the system the ability to identify, process and record transactions associated with real estate units managed by the system, wherein the transactions are between users of the system. The transactions may include, but are not limited to: generation of a housing club contract; formation of a housing club; updates to housing club contracts; termination of housing club contracts; administration of housing club contracts (e.g., updating terms, updating owners); administration of other smart contracts; administration of social rankings or ratings of various users; recordation of social transactions; and any combination thereof. In preferred embodiments, the real estate transaction module is configured to handle processing and recording of the social aspects of the methods detailed herein. In these preferred embodiments, the real estate transaction module leverages distributed ledgers and smart contracts to affect and record the actions conducted and transacted by the real estate transaction module.

According to an embodiment of the present invention, a real estate transaction module 205 is further configured to provide matching abilities to the system. The real estate transaction module leverages information available and associated with various users to generate potential successful matches for those users amongst real estate units and the users living in those real estate units. Particularly, the real estate transaction module is used to determine whether a set of users would be compatible, based on criteria know about the users (e.g., social rankings/ratings, self-provided details, details provided by other users, demographics).

According to an embodiment of the present invention, a RE unit processing module 206 is configured to generate and process transactions associated with the real estate units managed and/or administered by the system. Transactions may include, but are not limited to: change of ownership; generating fractional divisions of a whole real estate unit; generating a joining of fractions associated with a real estate unit; processing of property management requests (e.g., maintenance, safety and security); processing of administrative/governmental requests (e.g., payment of taxes, submission of administrative forms); generation of valuations of real estate units; generation of equity valuations of users; processing of payment transactions associated with users; and any combination thereof.

The exemplary disclosed system and method may be used in any suitable application involving providing an ownership platform and/or providing a financial product to a consumer. For example, the exemplary disclosed system and method may be used in any suitable application involving providing a mortgage to a consumer.

Turning now to FIG. 3, an exemplary method for providing onboarding, configuration and exchange of real estate units into a real estate ownership mobility platform, in accordance with an embodiment of the present invention, is shown. The process starts at step 300 with the system being engaged to generate a set of FREUs out of a real estate unit. At step 302, the system receives a RE unit fractionalization request. The RE unit fractionalization request contains all the information and data the system needs to process a real estate unit into multiple FREUs.

At step 304, the system processes the RE unit fractionalization request into a RE unit dataset. The dataset comprises a parsed version of the request, placing the various data points into appropriate categories for use by the system in generating the FREU. In general, at a minimum, the dataset would identify the real estate unit to be fractionalized. Additional information is preferable, as having as much detail as possible increases the accuracy when preparing an optimal FREU set. In certain embodiments, the system may also be configured to retrieve additional data from third-party sources in order to increase the data in the dataset. For instance, multiple listing service (MLS) data may be used to pull information from a listing related to the real estate unit, and such information can supplement the data contained in the RE unit fractionalization request. One of ordinary skill in the art would appreciate that there are numerous third-party data sources that could be utilized with embodiments of the present invention, and embodiments of the present invention are contemplated for use with any third party data source.

At step 306, the system uses the RE unit dataset to generate a set of FREUs. As detailed previously herein, the system may be configured to use AI means, neural network means, or ML means to analyze the dataset and formulate a set of optimal FREUs based on the dataset.

At step 308, the system determines a value for each of the FREUs in the set of FREUs. Valuation of the FREUs can be accomplished in various manners. In preferred embodiments, data from the original RE unit dataset acts as a starting point for the valuation, providing useful information such as geographic location of the property, and potentially information about amenities and other information that would help with valuation calculations. With the information from the RE unit dataset, and information about the size and composition of each of the FREUs in the optimal set of FREUs, the system generates valuations for each of the FREUs. Similar to the generation of the optimal set of FREUs, valuation may be automated and utilize AI means, neural network means, or ML means to generate the valuations without need for user input. One of ordinary skill in the art would appreciate that there are numerous means for generating valuations, and embodiments of the present invention are contemplated for use with any appropriate means for valuation.

At step 310, the system generates tokens for each of the FREUs in the optimal set of FREUs. As described elsewhere herein, the tokens are comprised of information related to the underlying FREU, such as information identifying what and where a FREU is, and may also contain additional information associated with the FREU, such as information about a related housing club constitution.

At step 312, once the tokens are generated, the system then generates offerings for the set of optimal FREUs. Since this process is generally onboarding a new real estate unit, freshly fractionalized, onto an existing networked FREU platform, these offerings will generally be initial offerings; however, there are instances where a property was previously on a networked FREU platform, and taken off, and is being placed back on the networked FREU platform. In certain cases, where this is an entirely new set of FREUs from a original RE unit, the offering may include a matching and identification of appropriate matching users to ensure that the initial new owners are also suitable matches for the set of FREUs.

At step 314, the system places the tokens and offerings onto the networked FREU platform, and these FREUs may be transacted upon in accordance with the rules and terms of the networked FREU platform. At this point, the process terminates at step 316. It should be noted additionally that the FREU platform and the system may be one and the same or separate from one another. Embodiments of the present invention are contemplated for use with any such configurations.

Turning now to FIG. 4, an exemplary and detailed method for providing onboarding, configuration and exchange of real estate units into a real estate ownership mobility platform, in accordance with an embodiment of the present invention, is shown. The process starts at step 400 with the system being engaged to commit an onboarding transaction of a new RE unit onto a networked FREU platform. In this exemplary method, an optimal set of FREUs has already been prepared and the system is being engaged to tokenize and transact with the FREUs/tokens. This embodiment fits with where the networked FREU platform is configured to receive sets of FREUs and then generates its own tokens on the platform side. However, one of ordinary skill in the art would appreciate that there are numerous configurations that could be utilized, and embodiments of the present invention are contemplated for use with any appropriate configuration.

At step 402, the system receives a FREU onboarding request from a user. The FREU onboarding request generally comprises all the information the system needs to complete the onboarding of the FREUs as well as initiate the initial transactions on the FREUs.

At step 404, the system parses the FREU onboarding request, identifies the FREUs and generates values for each FREU. Valuation of each FREU may be accomplished in a manner similar to those detailed elsewhere herein.

At step 406, the system generates tokens for each FREU. The tokens may be generated in a manner similar to those detailed elsewhere herein. In the instance where a networked FREU platform is generating its own tokens, they may be proprietary to that networked FREU platform. Alternatively, a uniform FREU token may be generated and utilized by multiple networked FREU platforms.

At step 408, the system may use the tokens to generate initial offerings of the FREUs associated with those tokens. As detailed elsewhere herein, in certain embodiments, the initial offering may also comprise a matching process, to ensure new owners of the FREUs are compatible.

At step 410, the system will process and execute a transaction on the FREU. The FREU transaction may require a user to execute one or more smart contracts associated with the FREU offering, and also may require the exchange of currency and effect the transfer of ownership from the original FREU owner to the purchasing user.

At step 412, with the FREU transaction completed, the system settles the remaining portion of the transaction with the original FREU owner. This may comprise executing one or more financial transactions with the original FREU owner. Once completed, the process terminates at step 414.

Turning now to FIG. 5, an exemplary system for providing an ownership conveyance system is shown, in accordance with an embodiment of the present invention. The system comprises: one or more communications device, such as circuitry for wireless communications, circuitry for wired communications, circuitry for voice or data communications, or any other communications systems; one or more data stores 502, such as a database, file repository system, or other non-transitory storage medium; one or more processors 503, such as a central processing unit (CPU) or other specialized processing device; one or more memory devices 504, such as RAM, ROM, cache or other memory system; a mortgage processing module 505; and a trust processing module 506.

The embodiment shown in FIG. 5 is merely an exemplary embodiment of the present invention, and one of ordinary skill in the art would appreciate that the configuration could be adapted to use additional or fewer components, or otherwise combined or modified to provide the systems and methods detailed herein. As such, each of this modified embodiment is contemplated for use with the system and methods described herein.

Further, one of ordinary skill in the art would appreciate that portions of the system could be implemented in a variety of manners, such as locally on a computing device (e.g., smartphone), managed via a remote or distributed system and provided as a service (e.g., SaaS) layer between a contact and receiving elements of the user, or some combination thereof. As such, each of these implementations are contemplated for use with the system and methods described herein.

According to an embodiment of the present invention, the system may comprise one or more modules integrated or stored on a computer readable medium, or otherwise be accessible to a processor for instructing the processor to take various actions inline with the methods described herein. Modules may include, but are not limited to, a mortgage processing module 505, a trust processing module 506 or any combination thereof. One of ordinary skill in the art would appreciate that these modules could be implemented in various manners, and combined or further broken down into additional modules, depending on the architecture and implementation of the system.

In at least some exemplary embodiments, mortgage processing module 505 may generate fractionalizable mortgage instruments based for example on the exemplary disclosed datasets of real estate (RE) unit fractionalization module 105, tokenization module 106, real estate (RE) unit processing module 205, and/or RE unit transaction module 206. For example, mortgage processing module 505 may generate fractionalizable mortgage instruments based on the exemplary disclosed fractionalized units within the real estate unit and information added to the exemplary disclosed real estate unit that may be tokenized (e.g., data such as rules for a housing club constitution).

Mortgage processing module 505 may generate fractionalizable mortgage instruments based on data including pre-screening (e.g., credit check) and/or background checking (e.g., criminal data record check) of users (e.g., buyers obtaining the instruments). Mortgage processing module 505 may generate fractionalizable mortgage instruments including multiple payers and/or incomes (e.g., based on the above exemplary disclosed fractionalized units). Mortgage processing module 505 may generate fractionalizable mortgage instruments based on data of the exemplary disclosed real estate unit that may be tokenized (e.g., data such as rules for a housing club constitution that may include rules for expulsion that may prohibit future membership in the exemplary disclosed ownership system and that may provide an incentive for users to meet payment obligations under the exemplary disclosed mortgage instruments). For example, the exemplary disclosed mortgage instruments generated by mortgage processing module 505 may include housing club constitution data that may provide an incentive (e.g., a “social contract”) for users who obtain the exemplary disclosed mortgage instruments to meet payment obligations under the instruments, which may decrease a probability for default on the instruments. Also for example, because the exemplary disclosed fractionalizable mortgage instruments may be based on the above exemplary disclosed fractionalized units, users (e.g., members of the exemplary disclosed ownership system) may exchange equity stakes based on payment of the mortgage instruments generated by mortgage processing module 505 and may change (e.g., swap) to less expensive fractionalized units using the exemplary disclosed system. For example, if a user is experiencing difficulty meeting payment obligations of a given fractionalized unit, that user may switch (e.g., move) to a less expensive fractionalized unit and another user may switch (e.g., move) to the newly available fractionalized unit based on an operation of mortgage processing module 505. Users may thereby maintain ownership equity in the system while switching to a given fractionalized unit that may be appropriate for their circumstances (e.g., income). For example, a user experiencing difficulty paying for a given fractionalized unit (e.g., portion of a house) may switch to another fractionalized unit (e.g., portion of another house) of the exemplary disclosed system based on an operation of mortgage processing module 505.

In at least some exemplary embodiments, mortgage processing module 505 may utilize artificial intelligence means, neural network means, machine learning (ML) means, and/or any other suitable computer operation to identify early warning signals of default (e.g., default of payment of the exemplary disclosed fractionalizable mortgage instruments). For example, mortgage processing module 505 may determine that a social reputation of a user is being damaged based on any suitable data provided to the system such as missed payment data of the user, review data or other input data of other users, social media data, and/or any other suitable data provided to mortgage processing module 505. For example, mortgage processing module 505 may identify early warning signals based on credit management and/or spending analysis of a given user (e.g., based on any suitable data such as payment data, credit rating data, and/or any other suitable data). If early warning signals are identified, mortgage processing module 505 may operate to take early warning operations (e.g., actions). For example, mortgage processing module 505 may also operate to identify job openings, contacts, interview opportunities, and/or training opportunities to assist system users with finding a new job if appropriate. For example, mortgage processing module 505 may trigger financial advisor assistance protocol to assist a user if early warning signals are detected by mortgage processing module 505. For example, mortgage processing module 505 may provide data of employment opportunities to the buyer, activate financial advisor assistance protocols, and/or identify buyer equity to assist with payments. Mortgage processing module 505 may also communicate with trust processing module 506 to identify and utilize equity of users based on their ownership stake in the exemplary disclosed system to monetize and/or liquidate the equity to allow the user to meet payment obligations of the exemplary disclosed fractionalizable mortgage instruments. For example, mortgage processing module 505 may operate to allow increased mortgages or refinancing if suitable, which may be adjusted for price difference if a user member has an equity shortfall. For example, cash or downpayment may be provided from buyer equity co-investment (e.g., based on social equity or from peers or club members), 3rd party lenders, equity investors, and/or any other suitable source.

In at least some exemplary embodiments, mortgage processing module 505 and trust processing module 506 may operate to provide a user with an income stream (e.g., for example to meet payment obligations under the exemplary disclosed fractionalizable mortgage instrument) that may provide a payment safety net. Mortgage processing module 505 and trust processing module 506 may thereby provide a Co-Owner Foreclosure-Free Easily-Exchangeable (COFFEE) mortgage that may lower a probability of default on the exemplary disclosed mortgage instrument by a user. One of ordinary skill in the art would appreciate that there are numerous AI, neural network and ML techniques that could be utilized regarding the above disclosed exemplary features, and embodiments of the present invention are contemplated for use with any appropriate technique.

Trust processing module 506 may operate to assign property interests recorded in data of the exemplary disclosed fractionalizable mortgage instrument to a trust stored in trust processing module 506. The trust may be operated by a professional trustee (e.g., a financial institution or other suitable organization for operating a trust). The trust may own the property of the exemplary disclosed system (e.g., the property interests of the exemplary disclosed fractionalizable mortgage instruments). The users (e.g., buyers) who obtain the exemplary disclosed fractionalizable mortgage instrument for participation in the exemplary disclosed system may be beneficiaries of the trust that may include data stored and maintained by trust processing module 506. For example as further described herein, when a predetermined default event occurs, trust processing module 506 operates to automatically assign title of a given fractionalized unit associated with the fractionalizable mortgage instrument having the default event to an assignee of a lender of the fractionalizable mortgage instrument (e.g., a lender such as a financial institution that provided money to purchase the given fractionalized unit under the mortgage). For example, trust processing module 506 may communicate with an assignee module 550 (e.g., including components similar to those shown in FIG. 5) via communications device 501 to transfer data of the title to the assignee of the lender.

Trust processing module 506 may provide a fractionalized residential depository and management trusts (FRDM or FREEDOM TRUSTS, e.g., Freedom from Foreclosures for lenders). FREEDOM trusts of trust processing module 506 may be synchronized with the exemplary disclosed fractionalizable mortgage instruments of mortgage processing module 505. For example as described herein, the exemplary disclosed fractionalizable mortgage instruments may be provided by lenders and may include data of one or more predetermined (e.g., pre-agreed upon) default events (e.g., failure to meet payment obligations, failure to pay taxes, failure to maintain adequate insurance, failure to maintain the real estate unit, failure to meet obligations under a Club Constitution, and/or any other default conditions). When a default event (e.g., a final default event) occurs and is identified by trust processing module 506 (e.g., based on the exemplary disclosed machine learning), trust processing module 506 operates to automatically assign property title associated with the default event and fractionalizable mortgage instrument to the lender's assignee (e.g., assignee module 550 that may be associated with any suitable entity of the lender such as a legal entity that may take and own title). Trust processing module 506 may thereby operate without litigation or other proceedings as recorded in data of the exemplary disclosed fractionalizable mortgage instrument. For example in executing the exemplary disclosed fractionalizable mortgage instruments, system users (e.g., system members who are borrowers under the exemplary disclosed fractionalizable mortgage instruments) may have already agreed not to legally challenge such transfer (e.g., as set forth in the exemplary disclosed Club Constitution or other exemplary disclosed tokenized information). In at least some exemplary embodiments, trust processing module 506 may utilize artificial intelligence means, neural network means, machine learning (ML) means, and/or any other suitable computer operation to perform the exemplary disclosed operations.

Trust processing module 506 may thereby lower costs to lenders involving defaults and provide an ownership structure that reduces risk for and protects lenders. For example, trust processing module 506 may eliminate about 30% of lender write-offs caused by default and foreclosure due to legal costs and delays, property damage, and/or public foreclosure market degradation (e.g., once a foreclosure is publicly advertised).

Trust processing module 506 may also operate utilizing smart contracts and/or any other suitable transaction protocols for example to automatically transfer title. For example, trust processing module 506 may include information and features of trust instruments including data, software, and modules associated with smart contracts and/or any other suitable transaction protocols.

Mortgage processing module 505 and trust processing module 506 may operate with all sizes and types of residences (e.g., which may include fractional units for example as described herein), which may add significant value and demand to the home ownership market. The exemplary disclosed system and method may provide protected co-ownership through the exemplary disclosed fractionalizable mortgage instruments, owner mobility between locations, higher lender safety, and/or increased resale values of property.

The exemplary disclosed system and method may reduce expenses for both buyers and lenders. The exemplary disclosed system and method may provide for efficient fractionalization of homeowner equity interests and portability and mobility of those interests. The exemplary disclosed system and method may prevent litigation costs, delay costs due to judicial stalling, foreclosure damage, and loss of value to property caused by a “foreclosure label.”

Turning now to FIG. 6, an exemplary and detailed method for providing an ownership conveyance system, in accordance with an embodiment of the present invention, is shown. The process starts at step 600. At step 602, the exemplary disclosed system (e.g., mortgage processing module 505) analyzes prospective buyer data. For example, mortgage processing module 505 may receive input data (e.g., data of a request for a fractionalizable mortgage instrument) and analyze input data including pre-screening and/or background check data of users (e.g., buyers obtaining the instruments). At step 604, the exemplary disclosed system (e.g., mortgage processing module 505) generates and records data of agreement to the exemplary disclosed fractionalizable mortgage instrument. The data of agreement may include data of one or more predetermined (e.g., pre-agreed upon) default events (e.g., failure to meet payment obligations, failure to pay taxes, failure to maintain adequate insurance or a real estate unit, and/or any other default conditions) and/or the exemplary disclosed house rules.

At step 606, the exemplary disclosed system (e.g., mortgage processing module 505) performs early warning signals analysis for example as described above (e.g., based on social reputation data, analysis of spending and credit data, and/or any other suitable criteria). At step 608, the exemplary disclosed system (e.g., mortgage processing module 505) determines if early warning signals of default are identified for example as described above. If early warning signals are not identified, the exemplary disclosed system returns to step 606. If early warning signals are identified, the exemplary disclosed system proceeds to step 610. At step 610, the exemplary disclosed system (e.g., mortgage processing module 505 and/or trust processing module 506) takes early warning actions for example as described above (e.g., identify employment opportunities, activate financial advisor assistance protocols, identify and utilize buyer equity to assist with payments, and/or perform any other suitable operation).

At step 612, the exemplary disclosed system (e.g., mortgage processing module 505 and/or trust processing module 506) determines if early warning actions taken at step 610 are effective (e.g., if a risk of buyer default of the fractionalizable mortgage instrument is sufficiently reduced or substantially eliminated). If the early warning actions performed at step 610 are determined to be effective (e.g., by any suitable operation, for example including machine learning), the exemplary disclosed system returns to step 606. If the early warning actions performed at step 610 are determined to be ineffective, the exemplary disclosed system proceeds to step 614.

At step 614, the exemplary disclosed system (e.g., mortgage processing module 505 and/or trust processing module 506) determines if a default event (e.g., as described above) occurs. If a default event is not detected, the exemplary disclosed system returns to step 610. If a default event is detected, the exemplary disclosed system proceeds to step 616.

At step 616, the exemplary disclosed system (e.g., trust processing module 506) executes automatic transfer of the title (e.g., title data) for example as described above. For example, trust processing module 506 may automatically assign property title (e.g., property title data) of the real estate unit associated with the default event and fractionalizable mortgage instrument to the lender's assignee (e.g., assignee module 550). The exemplary process ends at step 618.

In at least some exemplary embodiments, the exemplary disclosed computerized method may provide an ownership conveyance system, said computerized method using a mortgage processing module, a trust processing module, a processor and a communications device. The method may comprise providing a fractionalizable mortgage instrument of a lender, receiving a mortgage instrument request data from a buyer for the fractionalizable mortgage instrument, generating a mortgage instrument agreement data for the fractionalizable mortgage instrument based on the mortgage instrument request data, receiving title data at the trust processing module of a fractionalized real estate unit purchased using the fractionalizable mortgage instrument, determining if a default event, which is based on the mortgage instrument agreement data, occurs, and automatically transferring title data from the trust processing module to an assignee module of the lender when the default event occurs. The buyer may be a beneficiary of a trust operated by the trust processing module. Automatically transferring title data from the trust processing module to the assignee module of the lender when the default event occurs may include automatically assigning a title of the fractionalized real estate unit purchased using the fractionalizable mortgage instrument from the trust to the assignee of the lender. The mortgage instrument agreement data may include agreement data indicating that the buyer agrees not to challenge the automatic assignment of the title of the fractionalized real estate unit from the trust to the assignee of the lender when the default event occurs. The exemplary disclosed method may also include analyzing buyer data including background check data of the buyer prior to generating the mortgage instrument agreement data. The exemplary disclosed method may further include determining if early warning signals of default are present. Early warning signals of default may include at least one selected from the group of missed payment data, credit management data, spending analysis data, and combinations thereof. The exemplary disclosed method may also include performing early warning operations if early warning signals are identified. Early warning operations may include at least one selected from the group of providing data of employment opportunities to the buyer, activating financial advisor assistance protocols, and/or identifying buyer equity to assist with payments, and combinations thereof. Automatically transferring title data from the trust processing module to the assignee module of the lender may include utilizing one or more smart contracts. At least one of said one or more smart contracts may be housing club constitution information of the mortgage instrument agreement data for the fractionalizable mortgage instrument. The fractionalized real estate unit may include a bedroom. The fractionalizable mortgage instrument may include at least one data of the fractionalized real estate unit selected from the group of a size of a bedroom, a location of a bedroom, an indication of a private bathroom, a size of one or more closets, an indication of proportion of size in comparison to an entire set of fractionalized real estate units, and combinations thereof.

In at least some exemplary embodiments, the exemplary disclosed computerized system may provide ownership conveyance. The exemplary disclosed system may include a mortgage processing module and a trust processing module, comprising computer-executable code stored in non-volatile memory, a processor, and one or more communications devices. The mortgage processing module and the trust processing module, the processor, and the one or more communications devices may be configured to provide a fractionalizable mortgage instrument of a lender, receive a mortgage instrument request data from a buyer for the fractionalizable mortgage instrument, generate a mortgage instrument agreement data for the fractionalizable mortgage instrument based on the mortgage instrument request data, receive title data at the trust processing module of a fractionalized real estate unit purchased using the fractionalizable mortgage instrument, determine if a default event, which is based on the mortgage instrument agreement data, occurs, and automatically transfer title data from the trust processing module to an assignee module of the lender when the default event occurs. The buyer may be a beneficiary of a trust operated by the trust processing module. Automatically transferring title data from the trust processing module to the assignee module of the lender when the default event occurs may include automatically assigning a title of the fractionalized real estate unit purchased using the fractionalizable mortgage instrument from the trust to the assignee of the lender. The mortgage instrument agreement data may include agreement data indicating that the buyer agrees not to challenge the automatic assignment of the title of the fractionalized real estate unit from the trust to the assignee of the lender when the default event occurs. The exemplary disclosed system may also include determining if early warning signals of default are present, and performing early warning operations if early warning signals are identified. Early warning signals of default may include at least one selected from the group of missed payment data, credit management data, spending analysis data, and combinations thereof. Early warning operations may include at least one selected from the group of providing data of employment opportunities to the buyer, activating financial advisor assistance protocols, and/or identifying buyer equity to assist with payments, and combinations thereof.

In at least some exemplary embodiments, the exemplary disclosed computerized method may provide an ownership conveyance system, said computerized method using a mortgage processing module, a trust processing module, a processor and a communications device. The exemplary disclosed method may include providing a fractionalizable mortgage instrument of a lender, receiving a mortgage instrument request data from a buyer for the fractionalizable mortgage instrument, generating a mortgage instrument agreement data for the fractionalizable mortgage instrument based on the mortgage instrument request data, receiving title data at the trust processing module of a fractionalized real estate unit, which includes a bedroom, purchased using the fractionalizable mortgage instrument, determining if a default event, which is based on the mortgage instrument agreement data, occurs, and automatically transferring title data from the trust processing module to an assignee module of the lender utilizing one or more smart contracts when the default event occurs, including automatically assigning a title of the fractionalized real estate unit purchased using the fractionalizable mortgage instrument from a trust to the assignee of the lender. The buyer may be a beneficiary of the trust operated by the trust processing module. The mortgage instrument agreement data may include agreement data indicating that the buyer agrees not to challenge the automatic assignment of the title of the fractionalized real estate unit from the trust to the assignee of the lender when the default event occurs. At least one of said one or more smart contracts may include housing club constitution information of the mortgage instrument agreement data for the fractionalizable mortgage instrument.

The exemplary disclosed system and method may provide an efficient and effective technique for providing home ownership and suitable financial products such as mortgages to a large segment of society. The exemplary disclosed system, apparatus, and method may provide a mortgage product involving a lower probability of default by users and a lower cost of default to mortgage lenders.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure, numerous references are made to servers, services, interfaces, engines, modules, clients, peers, portals, platforms, or other systems formed from computing devices. It should be appreciated that the use of such terms is deemed to represent one or more computing devices having comprising one or more processors (e.g., ASIC, FPGA, DSP, x86, ARM, ColdFire, GPU, multi-core processors) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions.

One of ordinary skill in the art would further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network. The terms “configured to” and “programmed to” in the context of a processor refer to being programmed by a set of software instructions to perform a function or set of functions.

While the inventive subject matter is susceptible of various modification and alternative embodiments, certain illustrated embodiments thereof are shown in the drawings and will be described below in detail. It should be understood, however, that there is no intention to limit the invention to the specific form disclosed, but on the contrary, the invention is to cover all modifications, alternative embodiments, and equivalents falling within the scope of the claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities or ranges, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified, thus fulfilling the written description of all Markush groups used in the appended claims.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A computerized method for providing an ownership conveyance system, said computerized method using a mortgage processing module, a trust processing module, a processor and a communications device, the method comprising:
providing a fractionalizable mortgage instrument of a lender;
receiving a mortgage instrument request data from a buyer for the fractionalizable mortgage instrument;
generating a mortgage instrument agreement data for the fractionalizable mortgage instrument based on the mortgage instrument request data;
receiving title data at the trust processing module of a fractionalized real estate unit purchased using the fractionalizable mortgage instrument;
determining if a default event, which is based on the mortgage instrument agreement data, occurs; and
automatically transferring title data from the trust processing module to an assignee module of the lender when the default event occurs;
wherein the buyer is a beneficiary of a trust operated by the trust processing module.

2. The method of claim 1, wherein automatically transferring title data from the trust processing module to the assignee module of the lender when the default event occurs includes automatically assigning a title of the fractionalized real estate unit purchased using the fractionalizable mortgage instrument from the trust to the assignee of the lender.

3. The method of claim 1, wherein the mortgage instrument agreement data includes agreement data indicating that the buyer agrees not to challenge the automatic assignment of the title of the fractionalized real estate unit from the trust to the assignee of the lender when the default event occurs.

4. The method of claim 1, further comprising analyzing buyer data including background check data of the buyer prior to generating the mortgage instrument agreement data.

5. The method of claim 1, further comprising determining if early warning signals of default are present.

6. The method of claim 5, wherein early warning signals of default include at least one selected from the group of missed payment data, credit management data, spending analysis data, and combinations thereof.

7. The method of claim 5, further comprising performing early warning operations if early warning signals are identified.

8. The method of claim 7, wherein early warning operations include at least one selected from the group of providing data of employment opportunities to the buyer, activating financial advisor assistance protocols, and/or identifying buyer equity to assist with payments, and combinations thereof.

9. The method of claim 1, wherein automatically transferring title data from the trust processing module to the assignee module of the lender includes utilizing one or more smart contracts.

10. The method of claim 9, wherein at least one of said one or more smart contracts includes housing club constitution information of the mortgage instrument agreement data for the fractionalizable mortgage instrument.

11. The method of claim 1, wherein the fractionalized real estate unit includes a bedroom.

12. The method of claim 1, wherein the fractionalizable mortgage instrument includes at least one data of the fractionalized real estate unit selected from the group of a size of a bedroom, a location of a bedroom, an indication of a private bathroom, a size of one or more closets, an indication of proportion of size in comparison to an entire set of fractionalized real estate units, and combinations thereof.

13. A computerized system for providing ownership conveyance, said system comprising:
a mortgage processing module and a trust processing module, comprising computer-executable code stored in non-volatile memory;
a processor; and
one or more communications devices;
wherein the mortgage processing module and the trust processing module, the processor, and the one or more communications devices are configured to:
provide a fractionalizable mortgage instrument of a lender;
receive a mortgage instrument request data from a buyer for the fractionalizable mortgage instrument;
generate a mortgage instrument agreement data for the fractionalizable mortgage instrument based on the mortgage instrument request data;
receive title data at the trust processing module of a fractionalized real estate unit purchased using the fractionalizable mortgage instrument;
determine if a default event, which is based on the mortgage instrument agreement data, occurs; and
automatically transfer title data from the trust processing module to an assignee module of the lender when the default event occurs;
wherein the buyer is a beneficiary of a trust operated by the trust processing module.

14. The system of claim 13, wherein automatically transferring title data from the trust processing module to the assignee module of the lender when the default event occurs includes automatically assigning a title of the fractionalized real estate unit purchased using the fractionalizable mortgage instrument from the trust to the assignee of the lender.

15. The system of claim 13, wherein the mortgage instrument agreement data includes agreement data indicating that the buyer agrees not to challenge the automatic assignment of the title of the fractionalized real estate unit from the trust to the assignee of the lender when the default event occurs.

16. The system of claim 13, further comprising:
determining if early warning signals of default are present; and
performing early warning operations if early warning signals are identified.

17. The system of claim 16, wherein:
early warning signals of default include at least one selected from the group of missed payment data, credit management data, spending analysis data, and combinations thereof; and
early warning operations include at least one selected from the group of providing data of employment opportunities to the buyer, activating financial advisor assistance protocols, and/or identifying buyer equity to assist with payments, and combinations thereof.

18. A computerized method for providing an ownership conveyance system, said computerized method using a mortgage processing module, a trust processing module, a processor and a communications device, the method comprising:
providing a fractionalizable mortgage instrument of a lender;
receiving a mortgage instrument request data from a buyer for the fractionalizable mortgage instrument;
generating a mortgage instrument agreement data for the fractionalizable mortgage instrument based on the mortgage instrument request data;
receiving title data at the trust processing module of a fractionalized real estate unit, which includes a bedroom, purchased using the fractionalizable mortgage instrument;
determining if a default event, which is based on the mortgage instrument agreement data, occurs; and
automatically transferring title data from the trust processing module to an assignee module of the lender utilizing one or more smart contracts when the default event occurs, including automatically assigning a title of the fractionalized real estate unit purchased using the fractionalizable mortgage instrument from a trust to the assignee of the lender;
wherein the buyer is a beneficiary of the trust operated by the trust processing module.

19. The method of claim 18, wherein the mortgage instrument agreement data includes agreement data indicating that the buyer agrees not to challenge the automatic assignment of the title of the fractionalized real estate unit from the trust to the assignee of the lender when the default event occurs.

20. The method of claim 18, wherein at least one of said one or more smart contracts includes housing club constitution information of the mortgage instrument agreement data for the fractionalizable mortgage instrument.
